(19) United States
(12) Patent Application Publication
(10) Pub. No.: US 2007/0071985 A1
(43) Pub. Date: Mar. 29, 2007

(54) Sputtering target, low resistivity, transparent conductive film, method for producing such film and composition for use therein

(76) Inventors: Prabhat Kumar, Framingham, MA (US); Gerhard Woetting, Coburg (DE); Rong-Chein Richard Wu, Chelmsford, MA (US)

Correspondence Address: BAYER MATERIAL SCIENCE LLC, 100 BAYER ROAD, PITTSBURGH, PA, 15205, US

(21) Appl. No.: 11/238,366

(22) Filed: Sep. 29, 2005

(51) Int. Cl. C04B 35/01

(52) U.S. Cl. 428/432; 428/701; 501/94; 501/126

(57) ABSTRACT

The present invention is directed to a composition consisting essentially of:
a) from about 0.1 to about 60 mole % of MoO₂,
b) from 0 to about 99.9 mole % of In₂O₃,
c) from 0 to about 99.9 mole % of SnO₂, d) from 0 to about 99.9 mole % of ZnO,
e) from 0 to about 99.9 mole % of Al₂O₃,
f) from 0 to about 99.9 mole % of Ga₂O₃, wherein the sum of components b) through f) is from about 40 to about 99.9 mole %, and wherein the mole %s are based on the total product and wherein the sum of components a) through e) is 100. The invention is also directed to the sintered product of such composition, a sputtering target made from the sintered product and a transparent electroconductive film made from the composition.

### BACKGROUND OF THE INVENTION

Indium oxide-tin oxide (In₂O₃—SnO₂) (“ITO”) is used to form transparent conductive film having high visible light transparency and high electrical conductivity and is used extensively in flat panel displays (“FPD”), touch screen panels, solar cells, light emitting diodes (“LED”), organic light emitting diodes (“OLED”) and architectural heat reflective, low emissivity coatings. While such ITO compositions have met with success, it would be desirable to replace all or part of the indium oxide in order to reduce the overall cost.

U.S. Pat. No. 6,193,856 describes a sputtering target wherein the target material comprises a metal oxide of the formula MOₓ, wherein M is at least one metal selected from the group consisting of Ti, Nb, Ta, Mo, W, Zr, and Hf, and wherein is MOₓ is a metal oxide which is deficient in oxygen as compared with the stoichiometric composition. The reference indicates that when M is Mo, x is in the range 2<x<3.

U.S. Pat. No. 6,689,477 (and its parent, U.S. Pat. No. 6,534,183) describe sputtering targets for transparent electroconductive film. One of the family of compositions described is a composition that contains one or more metal oxides selected from the group consisting of indium oxide, zinc oxide and tin oxide and one or more oxides selected from the group consisting of vanadium oxide, molybdenum oxide and ruthenium oxide. The reference does not define the meaning of the phrase “molybdenum oxide.” As is known, molybdenum can have valences of 2, 3, 4, 5 and 6. In general, where the art refers to “molybdenum oxide”, the oxide “molybdenum trioxide (MoO₃)” is meant.

In order to be commercially useful in FPDs, the film must have a resistivity of no more than 10³ ohm-cm and a light transmittance of at least 80%.

### DESCRIPTION OF THE INVENTION

The present invention is directed to a composition that can be used to produce a transparent conductive film, the sintered product of such composition, a sputtering target made from the sintered product and a transparent electroconductive film made from the composition.

More particularly, the present invention is directed to a composition consisting essentially of:

a) from about 0.1 to about 60 mole % of MoO₂,

b) from 0 to about 99.9 mole % of In₂O₃,

c) from 0 to about 99.9 mole % of SnO₂,

d) from 0 to about 99.9 mole % of ZnO,

e) from 0 to about 99.9 mole % of Al₂O₃,

f) from 0 to about 99.9 mole % of Ga₂O₃,

wherein the sum of components b) through f) is from about 40 to about 99.9 mole %, and wherein the mole % s are based on the total product and wherein the sum of components a) through e) is 100. The invention is also directed to the sintered product of such composition, a sputtering-target made from the sintered product and a transparent electroconductive film made from the composition.

Preferred ranges are

a) from about 1 to about 40 mole % of MoO₂,

b) from 0 to about 99 mole % of In₂O₃,

c) from 0 to about 99 mole % of SnO₂,

d) from 0 to about 99 mole % of ZnO,

e) from 0 to about 99 mole % of Al₂O₃,

f) from 0 to about 99 mole % of Ga₂O₃,

wherein the sum of components b) through f) is from about 60 to about 99 mole %.

More preferred ranges are

a) from about 1.5 to about 30 mole % of MoO₂,

b) from 0 to about 98.5 mole % of In₂O₃,

c) from 0 to about 98.5 mole % of SnO₂,

d) from 0 to about 98.5 mole % of ZnO,

e) from 0 to about 98.5 mole % of Al₂O₃,

f) from 0 to about 98.5 mole % of Ga₂O₃,

wherein the sum of components b) through f) is from about 70 to about 98.5 mole %.

The most preferred composition consists essentially of:

a) from about 2 to about 15% of MoO₂,

b) from 0 to about 85 mole % of In₂O₃,

c) from 0 to about 85 mole % of SnO₂,

d) from 0 to about 85 mole % of ZnO,

e) from 0 to about 85 mole % of Al₂O₃,

f) from 0 to about 85 mole % of Ga₂O₃,

wherein the sum of components b) through f) is from about 85 to about 98 mole %.

Three specifically preferred compositions (I, II and III) consist essentially of

I) a) from about 5 to about 10 mole % of MoO₂, and
b) from about 90 to about 95 mole % of In₂O₃,

II) a) from about 5 to about 10% of MoO₂, and
c) from about 90 to about 95 mole % of SnO₂, and

III) a) from about 5 to about 10% of MoO₂, and
d) from about 90 to about 95 mole % of ZnO,
   wherein i) in the case of composition I), the sum of components a) and b) totals 100 mole %, ii) in the case of composition II), the sum of components a) and c) totals 100 mole % and iii) i) in the case of composition III), the sum of components a) and d) totals 100 mole %

The films produced from these compositions are characterized by light transmittances (i.e., transparencies) of 80% or more, and in some instances by resistivities of no more than 10⁻³ ohm-cm.

The oxides used are uniformly ground and mixed in a suitable mixing and grinding machine (e.g., in a dry ball or wet ball or bead mill or ultrasonically). In case of wet processing, the slurry is dried and the dried cake broken up by sieving. Dry processed powders and mixtures are also sieved. The dry mixtures are granulated.

Concerning shaping into bodies of the desired shape, there are several processes that can be used.

First, a cold compaction process can be used. The shaping can be performed using substantially any appropriate process. Known processes for cold compaction are cold pressing and cold isostatic pressing (“CIP”). In cold pressing, the granulated mixture is placed in a mould and pressed to form a compact product. In cold isostatic pressing, the granulated mixture is filled into a flexible mould, sealed and compacted by means of a medium pressure being applied to the material from all directions.

Thermal consolidation without or with the application of mechanical or gas pressure can also be used. Thermal consolidation is preferably used for further densification and strengthening. The thermal consolidation can be performed using substantially any appropriate process. Known processes include sintering in vacuum, in air, in inert or reactive atmosphere at atmospheric pressure or increased gas pressure, hot pressing and hot isostatic pressing (“HIP”),

Sintering is performed by placing the shaped samples into an appropriate furnace and running a specified temperature-time gas-pressure cycle.

In the hot pressing process, the granulated mixture is placed in a mould and is sintered (or baked) with simultaneous mechanical pressing.

In the HIP process, there are at least two possibilities. In the first one, called sinter-HIP, the shaped sample is placed into the HIP-furnace and a temperature-time cycle at low gas-pressure is primarily run until the stage of closed pores is reached, corresponding with about 93-95% of the theoretical density. Then the gas-pressure is increased, acting as a densification supporting means to eliminate residual pores in the body.

In the second case, the so-called clad-HIP, the granulated mixture is placed in a closed mould made of refractory metal, evacuated and sealed. This mould is placed into the HIP-furnace and an appropriate temperature-time gas-pressure cycle is run. Within this cycle, the pressurized gas performs an isostatic pressing (i.e., pressure is applied to the mould and the material inside from all directions).

The raw material oxides are preferably ground as fine as possible (e.g., mean particle size no larger than 5 μm, preferably no larger than 1 μm). The shaped bodies are generally sintered (or baked) at a temperature of from about 500 to about 1600° C. for a period of time of from about 5 minutes to about 8 hours, with or without the application of mechanical or gas pressure to assist in densification.

Substantially any shape and dimension of sintered product can be produced. For example, the product can be square, rectangular, circular, oval or tubular. If desired, the shape can be the same as the desired sputtering target. Regardless of the shape of the sintered product, it is then machined into a size and shape will fit to an appropriate sputtering unit. As is known in the art, the shape and dimensions of the sputtering target can be varied depending on the ultimate use. For example, the sputtering targets may be square, rectangular, circular, oval or tubular. For large size targets, it may be desirable to use several smaller sized parts, tiles or segments that are bonded together to form the target. The targets so produced may be sputtered to form films on a wide variety of transparent substrates such as glass and polymer films and sheets. In fact, one advantage of the present invention is that transparent, electroconductive films can be produced from the compositions of the present invention by depositing at room temperature and the resultant film will have excellent conductivity and transparency.

In one embodiment, a plate made in accordance to the invention is made into a sputtering target. The sputtering target is made by subjecting the plate to machining until a sputtering target having desired dimensions is obtained. The machining process the plate is subjected to can include any machining suitable for making sputtering targets having suitable dimensions. Examples of suitable machining steps include but are not limited to laser cutting, water jet cutting, milling, turning, and lathe-techniques. The sputtering target may be polished to reduce its surface roughness. The dimensions and shapes of the plates can vary over a wide range.

Any suitable method of sputtering may be used in the invention. Suitable methods are those that are able to deposit a thin film on a plate (or substrate). Examples of suitable sputtering methods include, but are not limited to, magnetron sputtering, magnetically enhanced sputtering, pulse laser sputtering, ion beam sputtering, triode sputtering, radio frequency (RF) and direct current (DC) diode sputtering and combinations thereof. Although sputtering is preferred, other methods can be used to deposit thin films on the substrate plate. Thus, any suitable method of depositing a thin film in accordance with the invention may be used. Suitable methods of applying a thin film to a substrate include, but are not limited to, electron beam evaporation and physical means such as physical vapor deposition.

The thin film applied by the present method can have any desired thickness. The film thickness can be at least 0.5 nm, in some situations 1 nm, in some cases at least 5 nm, in other cases at least 10 nm, in some situations at least 25 nm, in other situations at least 50 nm, in some circumstance at least 75 nm, and in other circumstances at least 100 nm. Also, the film thickness can be up to 10 μm, in some cases up to 5 μm, in other cases up to 2 μm, in some situations up to 1 μm, and in other situations up to 0.5 μm. The film thickness can be any of the stated values or can range between any of the values stated above.

The thin films can be used in flat panel displays (including television screens and computer monitors), touch screen panels (such as are used, e.g., in cash registers, ATMs and PDAs), organic light-emitting diodes (such as are used, e.g., in automotive display panels, cell phones, games and small commercial screens), static dissipaters, electromagnetic interference shielding, solar cells, electrochromic mirrors, LEDs, sensors, other electronic and semiconductor devices and architectural heat reflective, low emissivity coatings.

The invention will now be described in more detail with reference to the examples which follow. In the examples, the following powders were used:
i) In₂O₃—OX-1075 Type 2, commercially available from Umicore Indium Products, having a purity >99.9% and a mean particle diameter of <10 μm
ii) MoO₂—MMP3230, commercially available from H.C. Starck, Inc., having a purity >99.9% and a mean particle diameter of <10 μm
iii) SnO₂—13123JOPO, high purity powder, commercially available from Sigma-Aldrich, having a purity >99.9% and a mean particle diameter of <10 μm
iv) ZnO—K33238449, high purity powder, commercially available from Sigma-Aldrich, having a purity >99.9% and a mean particle diameter of <10 μm
v) Al₂O₃—CT3000SG, commercially available from Alcoa, having a purity of >99.9% and a mean particle diameter of <5 μm
   General Procedure Used in the Examples:

The powders in the weight ratios noted were poured into a PVA plastic bottle, together with the same total weight amount of Al₂O₃ balls of 8-10 mm diameter. The mixture was comminuted by rotating the bottle at a rate of 60 times per minute for 12 hours. This comminuted material was emptied on a sieve of 500 μm opening size and the balls removed. In a second step, the powder was passed through a sieve with size 150 μm.

In each example, 250 parts by weight of the powder were filled into a graphite hot-pressing mould of 100 mm diameter which was isolated against the powder by a graphite foil. This filled mould was placed in a vacuum tight hot-press, the vessel evacuated and heated up to 300° C. to remove enclosed air and humidity and then refilled with argon. Then, a pressure of 25 MPa was applied and the temperature increased by 5K/minute. By use of the displacement measuring device of the hot press, densification could be recorded. Heating-up was stopped when the displacement rate approached zero, followed by a 15 minute holding time at this maximum temperature. Then, the temperature was reduced in a controlled manner of 10K/minute to 600° C., simultaneously the pressure was reduced. Then, the furnace was shut-off to cool down completely. The temperature where densification ceased was noted.

After removing the consolidated sample from the cold mould, the part was cleaned and the density determined.

For film deposition experiments, the sample was ground on its flat sides to remove contaminations and machined by water-jet cutting to a 3″ disc. Deposition was performed on a sapphire substrate using a PLD-5000 system commercially available from PVD Products at the temperature noted and under the conditions noted. The thickness of the deposited film was about 100 nm.

In those examples where film deposition experiments were conducted (i.e., Examples 1 through 6), light transmittance and resistivity were then measured as indicated. In Examples 9-11, bulk resistivity was measured.

Light transmittance was measured using a Model TFProbe ST 200 spectrophotometer having a spectrum range of from 250 to 1100 nm (with resolution of 1 nm), available from Angstrom Sun Technologies. The unit was equipped with Advanced TFProbe 2.0 Data Acquisition and Analysis with Simulation Capacity. The transmittance numbers reported represent the average of light transmittance from 400 to 750 nm.

Resistivities of the films of Examples 1 through 6 were measured according to the known 4-point probe method. For Examples 9, 10 and 11, the bulk resistivities were measured using the known four-wire method.

### EXAMPLE 1

### 95 Mole % In₂O₃-5 Mole % MoO₂

95.37 parts of In₂O₃ and 4.63 parts of MoO₂

The temperature where densification ceased was 975° C.

The calculated theoretical density of this composition was 7.15 g/cm³ and the measured density was 5.33 g/cm³.

Conditions of deposition: The thin films were deposited with a 320 mJ laser pulse at 25 Hz with an oxygen pressure of 10 mTorr and for a period of 100 seconds.

Resistivity/room temperature deposition—8.48×10⁻⁴ Ω-cm

Transmittance/room temperature deposition—90.97%

Resistivity/300° C. deposition—1.059×10⁻³ Ω-cm

Transmittance/300° C. deposition—89.12%

### EXAMPLE 2

### 90 Mole % SnO₂-10 Mole % MoO₂

91.38 parts of SnO₂ and 8.62 parts of MoO₂

The temperature where densification ceased was 975° C.

The calculated theoretical density of this composition was 6.91 g/cm³ and the measured density was 6.41 g/cm³.

Conditions of deposition: The thin films were deposited with a 320 mJ laser pulse at 25 Hz with an oxygen pressure of 10 mTorr and for a period of 72 seconds.

Resistivity/room temperature deposition—not conducting

Transmittance/room temperature deposition—81.97%

Resistivity/300° C. deposition—1.296×10⁻¹ Ω-cm

Transmittance/300° C. deposition—87.19%

### EXAMPLE 3

### 95 Mole % ZnO-5 Mole % MoO₂

92.36 parts of ZnO and 7.64 parts of MoO₂

The temperature where densification ceased was 1000° C.

The calculated theoretical density of this composition was 5.67 g/cm³ and the measured density was 5.13 g/cm³.

Conditions of deposition: The thin films were deposited with a 320 mJ laser pulse at 25 Hz with an oxygen pressure of 10 mTorr and for a period of 106 seconds.

Resistivity/room temperature deposition—not conducting

Transmittance/room temperature deposition—92.52%

Resistivity/300° C. deposition—3.330 Ω-cm

Transmittance/300° C. deposition—91.10%

### EXAMPLE 4

### 95 Mole % SnO₂-5 Mole % MoO₂

95.72 parts of SnO₂ and 4.28 parts of MoO₂

The temperature where densification ceased was 975° C.

The calculated theoretical density of this composition was 6.93 g/cm³ and the measured density was 6.51 g/cm³.

Conditions of deposition: The thin films were deposited with a 320 mJ laser pulse at 25 Hz with an oxygen pressure of 10 mTorr and for a period of 66 seconds.

Resistivity/room temperature deposition—not conducting

Transmittance/room temperature deposition—84.29%

Resistivity/300° C. deposition—8.910×10⁻³ Ω-cm

Transmittance/300° C. deposition—89.80%

### EXAMPLE 5

### 90 Mole % In₂O₃-10 Mole % MoO₂

90.71 parts of In₂O₃ and 9.29 parts of MoO₂

The temperature where densification ceased was 975° C.

The calculated theoretical density of this composition was 7.11 g/cm³ and the measured density was 5.51 g/cm³.

Conditions of deposition: The thin films were deposited with a 320 mJ laser pulse at 25 Hz with an oxygen pressure of 10 mTorr and for a period of 85 seconds.

Resistivity/room temperature deposition—4.270×10⁻³ Ω-cm

Transmittance/room temperature deposition—86.50%

Resistivity/300° C. deposition—1.205×10⁻² Ω-cm

Transmittance/300° C. deposition—86.30%

### EXAMPLE 6

### 90 Mole % ZnO-10 Mole % MoO₂

85.13 parts of ZnO and 14.87 parts of MoO₂

The temperature where densification ceased was 1000° C.

The calculated theoretical density of this composition was 5.73 g/cm³ and the measured density was 5.45 g/cm³.

Conditions of deposition: The thin film was deposited with a 320 mJ laser pulse at 25 Hz with an oxygen pressure of 10 mTorr and for a period of 116 seconds.

Resistivity at room temperature deposition—not conducting

Transmittance/room temperature deposition—91.50%

Resistivity/300° C. deposition—not conducting

Transmittance/300° C. deposition—83.10%

### EXAMPLE 7

### 47.5 Mole % SnO₂/47.5 Mole % ZnO/5 Mole % MoO₂

61.37 parts of SnO₂, 33.15 parts of ZnO and 5.48 parts of MoO₂

The temperature where densification ceased was 810° C.

The calculated theoretical density of this composition was 6.48 g/cm³ and the measured density was 6.27 g/cm³.

### EXAMPLE 8

### 95 Mole % Al₂O₃-5 Mole % MoO₂

93.81 parts of Al₂O₃ and 6.19 parts of MoO₂

The temperature where densification ceased was 1300° C.

The calculated theoretical density of this composition was 4.13 g/cm³ and the measured density was 3.88 g/cm³.

### EXAMPLE 9

### 67 Mole % ZnO-33 Mole % MoO₂

56.65 parts of ZnO and 43.35 parts of MoO₂

The temperature where densification ceased was 1000° C.

The calculated theoretical density of this composition was 5.94 g/cm³ and the measured density was 4.57 g/cm³.

Bulk resistivity-5.19×10⁻¹ Ω-cm

### EXAMPLE 10

### 58 Mole % SnO₂-42 Mole % MoO₂

61.81 parts of SnO₂ and 38.19 parts of MoO₂

The temperature where densification ceased was 950° C.

The calculated theoretical density of this composition was 6.75 g/cm³ and the measured density was 6.47 g/cm³.

Bulk resistivity—6.1×10⁻² Ω-cm

### EXAMPLE 11

### 43 Mole % In₂O₃-57 Mole % MoO₂

62.58 parts of In₂O₃ and 37.42 parts of MoO₂

The temperature where densification ceased was 955° C.

The calculated theoretical density of this composition was 6.88 g/cm³ and the measured density was 4.07 g/cm³.

Bulk resistivity—2.0×10⁻³ Ω-cm

Although the invention has been described in detail in the foregoing for the purpose of illustration, it is to be understood that such detail is solely for that purpose and that variations can be made therein by those skilled in the art without departing from the spirit and scope of the invention except as it may be limited by the claims.

What is claimed is:

1. A composition consisting essentially of:
a) from about 0.1 to about 60 mole % of MoO₂,
b) from 0 to about 99.9 mole % of In₂O₃,
c) from 0 to about 99.9 mole % of SnO₂,
d) from 0 to about 99.9 mole % of ZnO,
e) from 0 to about 99.9 mole % of Al₂O₃,
f) from 0 to about 99.9 mole % of Ga₂O₃,
wherein the sum of components b) through f) is from about 40 to about 99.9 mole %, and wherein the mole %s are based on the total product and wherein the sum of components a) through e) is 100.

2. The composition of claim 1, consisting essentially of:
a) from about 1 to about 40 mole % of MoO₂,
b) from 0 to about 99 mole % of In₂O₃,
c) from 0 to about 99 mole % of SnO₂,
d) from 0 to about 99 mole % of ZnO,
e) from 0 to about 99 mole % of Al₂O₃,
f) from 0 to about 99 mole % of Ga₂O₃,
wherein the sum of components b) through f) is from about 60 to about 99 mole %.

3. The composition of claim 2, consisting essentially of:
a) from about 1.5 to about 30 mole % of MoO₂,
b) from 0 to about 98.5 mole % of In₂O₃,
c) from 0 to about 98.5 mole % of SnO₂,
d) from 0 to about 98.5 mole % of ZnO,
e) from 0 to about 98.5 mole % of Al₂O₃,
f) from 0 to about 98.5 mole % of Ga₂O₃,
wherein the sum of components b) through f) is from about 70 to about 98.5 mole %.

4. The composition of claim 3, consisting essentially of:
a) from about 2 to about 15% of MoO₂,
b) from 0 to about 85 mole % of In₂O₃,
c) from 0 to about 85 mole % of SnO₂,
d) from 0 to about 85 mole % of ZnO,
e) from 0 to about 85 mole % of Al₂O₃,
f) from 0 to about 85 mole % of Ga₂O₃,
wherein the sum of components b) through f) is from about 85 to about 98 mole %

5. A composition consisting essentially of
a) from about 5 to about 10 mole % of MoO₂, and
b) from about 90 to about 95 mole % of In₂O₃,
wherein the sum of components a) and b) totals 100 mole %.

6. A composition consisting essentially of
a) from about 5 to about 10% of MoO₂, and
c) from about 90 to about 95 mole % of SnO₂,
wherein the sum of components a) and c) totals 100 mole %.

7. A composition consisting essentially of
a) from about 5 to about 10% of MoO₂, and
d) from about 90 to about 95 mole % of ZnO,
wherein the sum of components a) and d) totals 100 mole %.

8. A sintered product prepared by sintering the composition of claim 1.

9. A sintered product prepared by sintering the composition of claim 5.

10. A sintered product prepared by sintering the composition of claim 6.

11. A sintered product prepared by sintering the composition of claim 7.

12. A sputtering target comprising the product prepared by sintering the composition of claim 1.

13. A sputtering target comprising the product prepared by sintering the composition of claim 5.

14. A sputtering target comprising the product prepared by sintering the composition of claim 6.

15. A sputtering target comprising the product prepared by sintering the composition of claim 7.

16. A transparent electroconductive film prepared by forming on the surface of a substrate, a transparent electroconductive layer of a composition consisting essentially of the composition of claim 1.

17. A transparent electroconductive film prepared by forming on the surface of a substrate, a transparent electroconductive layer of a composition consisting essentially of the composition of claim 5.

18. A transparent electroconductive film prepared by forming on the surface of a substrate, a transparent electroconductive layer of a composition consisting essentially of the composition of claim 6.

19. A transparent electroconductive film prepared by forming on the surface of a substrate, a transparent electroconductive layer of a composition consisting essentially of the composition of claim 7.
